(19) United States
(12) Patent Application Publication
(10) Pub. No.: US 2025/0296345 A1
(43) Pub. Date: Sep. 25, 2025

(54) CARTRIDGE, METHOD OF DISASSEMBLING CARTRIDGE, AND METHOD OF REMANUFACTURING CARTRIDGE

(71) Applicant: CANON KABUSHIKI KAISHA, Tokyo (JP)

(72) Inventor: KAZUNORI YABE, Tokyo (JP)

(21) Appl. No.: 19/081,587

(22) Filed: Mar. 17, 2025

(30) Foreign Application Priority Data
Mar. 19, 2024 (JP) 2024-043876

(51) Int. Cl. B41J 2/175

(52) U.S. Cl. CPC B41J 2/17553; B41J 2/17506; B41J 2/17513

(57) ABSTRACT

In a method of disassembling a cartridge, the cartridge including a liquid storage member including an opening and configured to store liquid, and a lid member configured to cover the opening, the liquid storage member and the lid member being joined at a joining portion, a gap being provided between a rear surface of the lid member and the liquid storage member, the method includes separating the liquid storage member and the lid member by inserting a member from the gap and causing the member to abut on the joining portion.

### BACKGROUND

### Field

The present disclosure relates to a cartridge, a method of disassembling the cartridge, and a method of remanufacturing the cartridge.

### Description of the Related Art

A liquid ejection apparatus is mounted with a liquid ejection head for ejecting liquid, and ejects the liquid to achieve various purposes. For example, in an inkjet recording apparatus, an inkjet recording head for ejecting liquid is mounted on a carriage, and ejects ink to a recording medium to record an image, characters, and the like. The liquid ejected from the liquid ejection apparatus is supplied to the liquid ejection head from a cartridge attachable to/detachable from the liquid ejection apparatus.

The cartridge includes a liquid storage member that includes an opening and stores the liquid, and a lid member that is joined to the liquid storage member. In recent years, in terms of environment protection, the reuse of the cartridge is desirable. To reuse the liquid storage member of the used cartridge, it is desirable to replenish the liquid storage member with new liquid after old liquid inside the liquid storage member is drained away. To do so, it is useful to separate the liquid storage member and the lid member, and to disassemble the cartridge.

Japanese Patent Application Laid-Open No. 2000-108369 discusses a method of disassembling a cartridge by performing cutting at a gap between the liquid storage member and the lid member to separate the liquid storage member and the lid member.

However, in a case where the liquid storage member and the lid member are separated by cutting, a considerable amount of chips is generated by cutting. The chips may adhere to a processing apparatus by static electricity, or may be mixed into liquid of the reused cartridge. In particular, if the chips are mixed into ink in an ink cartridge, the chips may cause clogging of the liquid ejection head receiving the ink from the ink cartridge.

### SUMMARY

The present disclosure is directed to a cartridge, a method of disassembling the cartridge that suppresses a possibility of occurrence of chips when a liquid storage member and a lid member are separated from each other, and a method of remanufacturing the cartridge.

According to some embodiments, in a method of disassembling a cartridge, the cartridge including a liquid storage member including an opening and configured to store liquid, and a lid member configured to cover the opening, the liquid storage member and the lid member being joined at a joining portion, a gap being provided between a rear surface of the lid member and the liquid storage member, the method includes separating the liquid storage member and the lid member by inserting a member from the gap and causing the member to abut on the joining portion.

Further features of the present disclosure will become apparent from the following description of exemplary embodiments with reference to the attached drawings.

### BRIEF DESCRIPTION OF THE DRAWINGS

FIG. 1 is schematic diagram of a liquid ejection apparatus.

FIG. 2 is a perspective view of a cartridge.

FIG. 3 is an exploded perspective view of the cartridge.

FIG. 4 is an outline diagram of a system separating a lid member from a liquid storage member.

FIG. 5 is an enlarged view of a joining portion between the liquid storage member and the lid member.

FIG. 6 is a flowchart illustrating a method of disassembling the cartridge.

FIG. 7A is an outline diagram illustrating a step of pressing a separation pin against the joining portion, and FIG. 7B is a schematic diagram illustrating an angle of a front end of the separation pin.

FIG. 8A is a cross-sectional view of the cartridge as viewed from an X direction, and FIGS. 8B, 8C, 8D, and 8E are enlarged views each illustrating the joining portion between the liquid storage member and the lid member.

FIG. 9 is a flowchart illustrating a method of remanufacturing the cartridge.

### DESCRIPTION OF THE EMBODIMENTS

Some exemplary embodiments, features, and aspects of the present disclosure are described below with reference to drawings. The following exemplary embodiments do not limit disclosed matters, and all of combinations of features described in the exemplary embodiments are not necessarily essential for solving means of the present disclosure. The same components are denoted by the same reference numerals.

### Inkjet Recording Apparatus

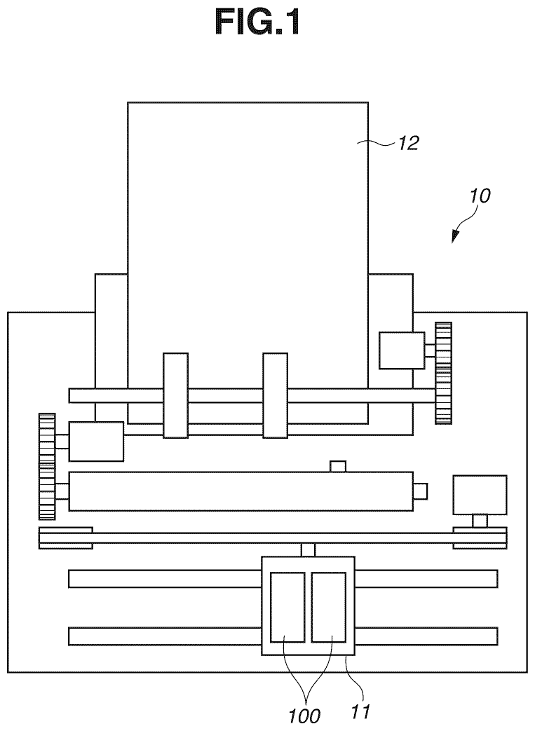

FIG. 1 is a schematic diagram of a liquid ejection apparatus according to a first exemplary embodiment. The liquid ejection apparatus according to the first exemplary embodiment is an inkjet recording apparatus, but is not limited thereto as long as the apparatus ejects liquid. An inkjet recording apparatus 10 (hereinafter, also referred to as recording apparatus) is of a serial recording on-carriage type, and includes a cartridge 100 and a carriage 11. The cartridge 100 is mounted on the carriage 11. In the recording apparatus 10, the carriage 11 reciprocates, and a recording sheet 12 is conveyed by a predetermine amount in a direction orthogonal to a reciprocation direction of the carriage 11. The cartridge 100 ejects ink to the recording sheet 12, thereby forming an image on the recording sheet 12.

### Cartridge

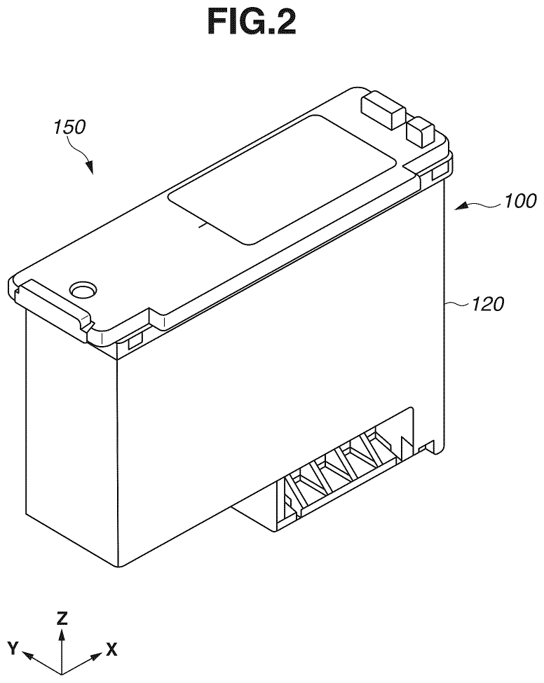

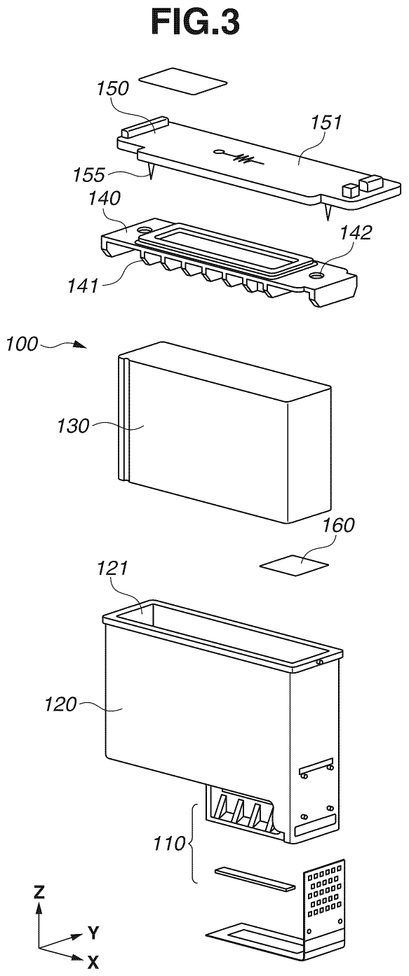

FIG. 2 is a perspective view of the cartridge 100 according to the first exemplary embodiment, and FIG. 3 is an exploded perspective view of the cartridge 100 according to the first exemplary embodiment. The cartridge 100 stores ink of one color, and is generally a cartridge for black ink. The present exemplary embodiment is applicable to a cartridge storing ink of a plurality of colors that is generally a cartridge for color ink (cyan, magenta, and yellow); however, in the present exemplary embodiment, the cartridge for black ink is described.

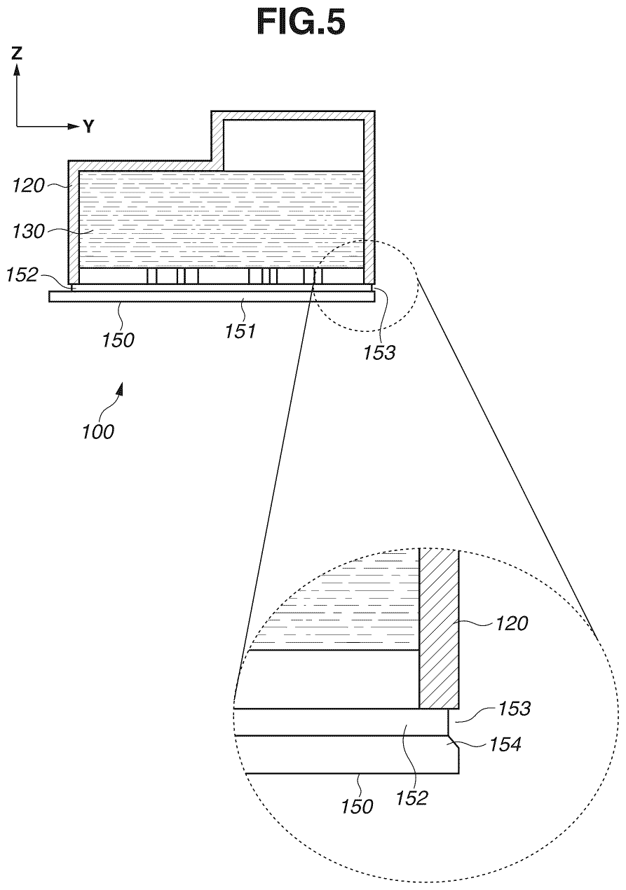

The cartridge 100 includes an absorber 130 holding liquid, a liquid storage member 120 that includes an opening 121 and stores the absorber 130 and the liquid, a lid member 150 (also referred to as first lid member) covering the opening 121, and a joining portion where the lid member 150 is joined to the liquid storage member 120. The liquid storage member 120 and the lid member 150 are joined by thermal welding or the like. In a case where the liquid storage member 120 and the lid member 150 are joined by thermal welding, the lid member 150 includes a flat plate portion 151 and a convex portion 152 (also referred to as welding rib) protruding from the flat plate portion in a thickness direction (−Z direction) of the flat plate portion (FIG. 5). When the convex portion 152 is joined to the liquid storage member 120, the joining portion is formed. To firmly weld the lid member 150 and the liquid storage member 120, the convex portion 152 is preferably provided over a circumferential direction of the opening 121. In a case where the liquid storage member 120 is reused, the lid member 150 preferably includes a welding rib. In a case where the lid member 150 is reused, the liquid storage member 120 preferably includes a convex portion (welding rib). In consideration of a plastic amount reduced in reuse, the liquid storage member 120 having a large volume is preferably reused. As described in detail below, a gap (FIG. 5) is provided between the liquid storage member 120 and a rear surface of the lid member 150 (flat plate portion 151).

The absorber 130 is made of a fiber body, a porous body, or the like, and can internally hold the ink by capillary force. The absorber 130 is preferably stored in the liquid storage member 120 while abutting on a filter 160 for removing foreign matters.

The cartridge 100 according to the present exemplary embodiment further includes a liquid ejection head 110 for ejecting the liquid, on a lower bottom surface of the liquid storage member 120 in a vertical direction. The liquid ejection head may be provided in a member different from the cartridge 100.

The cartridge 100 preferably further includes a partition member 140 that is disposed between the absorber 130 and the lid member 150 and includes a protrusion 141 abutting on the absorber 130. When the protrusion 141 abuts on the absorber 130 to hold down the absorber 130, the absorber 130 and the filter 160 can be caused to abut on each other, and supply of the liquid from the cartridge can be stabilized. The partition member 140 may be integrated with the lid member 150, and the lid member 150 may include a protrusion abutting on the absorber 130. The lid member 150 and the partition member 140 are preferably different members because the partition member 140 not joined to the liquid storage member 120 can be reused. Further, a support portion 155 of the lid member 150 and a fitting portion 142 of the partition member 140 are preferably fitted to each other. Since the lid member 150 is joined to the liquid storage member 120, it is possible to suppress positional deviation of the partition member 140 fitted to the lid member 150. The support portion 155 and the fitting portion 142 are preferably thermally swaged because the support portion 155 and the fitting portion 142 can be assembled with a simple configuration.

### Method of Disassembling Cartridge

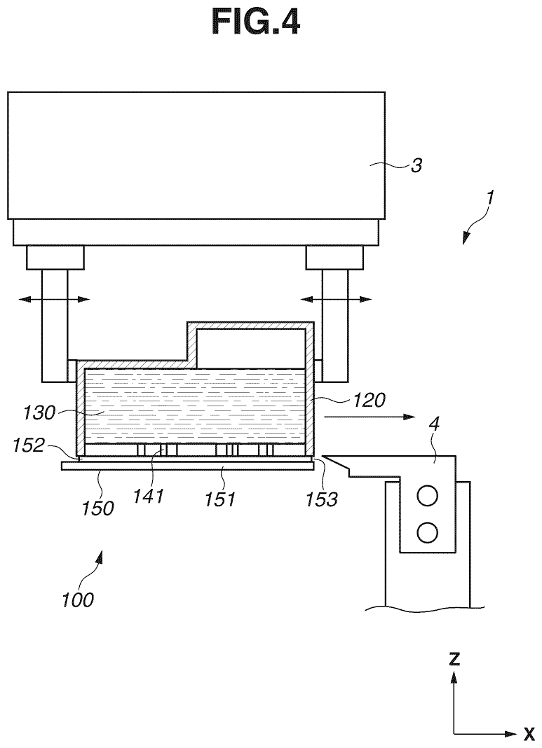

Next, a process of separating the lid member 150 from the liquid storage member 120 that is a feature of the present exemplary embodiment is described in detail. FIG. 4 is a diagram illustrating an outline configuration of a system separating the lid member 150 from the liquid storage member 120 of the cartridge 100. As illustrated in FIG. 4, a separation apparatus 1 includes a gripper 3 holding the cartridge 100, and a separation pin 4 (also referred to as member) for separating the lid member 150 from the liquid storage member 120. The gripper 3 has a function of holding and transferring the cartridge 100, and a function of pressing the held cartridge 100 against the separation pin 4. The gripper 3 preferably has an elastic body such as a rubber at a front end in order to reduce a possibility that the gripper 3 damages the cartridge 100 when holding the cartridge 100.

FIG. 5 is an enlarged view of a joining portion between the liquid storage member 120 and the lid member 150 of the cartridge 100. As described above, in the cartridge 100, the rear surface of the lid member 150 and the liquid storage member 120 are joined with the gap 153 in between. In other words, the gap 153 is provided between the flat plate portion 151 and the liquid storage member 120. Further, as described below, the separation pin 4 is pushed into the joining portion (convex portion 152) between the liquid storage member 120 and the lid member 150 from the gap 153. Thus, the gap 153 is provided on the outside of the convex portion 152 provided over the circumferential direction of the opening 121.

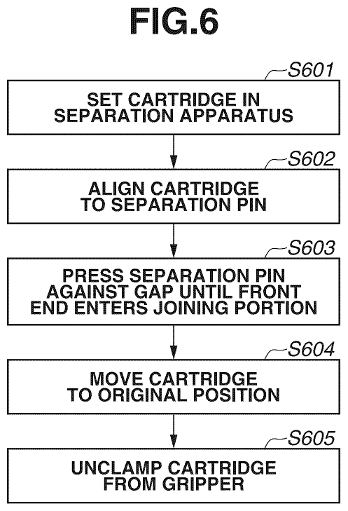

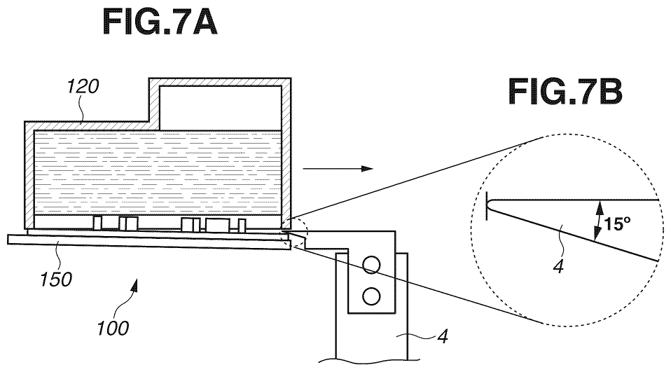

FIG. 6 illustrates a flow of a method of disassembling the cartridge. In step S601, the lid member 150 of the cartridge 100 is set in the separation apparatus 1 as illustrated in FIG. 4, manually or by an apparatus. In other words, the gripper 3 holds surfaces of the cartridge 100 in a longitudinal direction (X direction) from both sides by optional force. In FIG. 4, the lid member 150 of the cartridge 100 is directed downward, but the cartridge 100 may be vertically turned over. In step S602, the cartridge 100 is aligned such that the gap 153 of the cartridge 100 rightly faces the separation pin 4. In step S603, as illustrated in FIG. 7A, the separation pin 4 is pressed against the gap 153 until a front end of the separation pin 4 enters the joining portion by about 30 millimeters (mm). As a result, force is gradually applied in a direction in which the lid member 150 is separated from the liquid storage member 120, the welded portion between the lid member 150 and the liquid storage member 120 is peeled, and the lid member 150 is accordingly separated from the liquid storage member 120. The separated lid member 150 falls down, and is collected in one place by a shooter or the like (not illustrated). A pressing distance of the separation pin 4 is not limited to 30 mm, and the front end of the separation pin 4 preferably has a sharp shape enough to enter the joining portion. Further, as illustrated in FIG. 7B, an angle of the front end of the separation pin 4 is preferably an acute angle of about 15 degrees. As the angle is increased, the stress of the lid member 150 is increased, and the lid member 150 may be damaged.

Further, as illustrated in FIG. 5, the lid member 150 preferably includes an inclined surface 154 that is connected to the gap 153 and is inclined toward the gap 153. Even in a case where positional deviation occurs when the gap 153 of the cartridge 100 is brought close to the separation pin 4, the separation pin 4 can be guided to the joining portion from the gap 153 along the inclined surface 154. The inclined surface 154 preferably has, for example, an inclination angle of 45 degrees, a depth (length in X direction) of about 0.5 mm, and a width (length in Y direction) of about 1 mm.

As illustrated in FIG. 7A, the gap 153 is provided on a surface of the lid member 150 in a longitudinal direction (X direction), and the separation pin 4 is preferably inserted into the gap 153 in the longitudinal direction. As a result, as compared with a case where the separation pin 4 is inserted into the gap 153 in a transverse direction (Y direction) of the lid member 150, an area of the joining portion (convex portion 152) to be peeled is reduced. Therefore, the lid member 150 can be easily separated from the liquid storage member 120.

In step S604, the cartridge 100 held by the gripper 3 is transferred to an original position. In step S605, the gripper 3 unclamps the cartridge 100, and the process of separating the lid member 150 from the liquid storage member 120 ends.

By the above-described process, the liquid storage member 120 and the lid member 150 can be separated while suppressing a possibility of occurrence of chips as compared with a case where the liquid storage member 120 and the lid member 150 are separated by cutting. Furthermore, it is possible to reduce a possibility that the liquid storage member 120 is damaged. This enables reuse of the liquid storage member 120 separated from the lid member 150, and remanufacture of the cartridge 100. A method of remanufacturing the cartridge 100 is described below.

A configuration of the cartridge 100 according to a second exemplary embodiment of the present disclosure is described. In the following description, only differences from the first exemplary embodiment are mainly described, and description of portions similar to the portions according to the first exemplary embodiment is omitted.

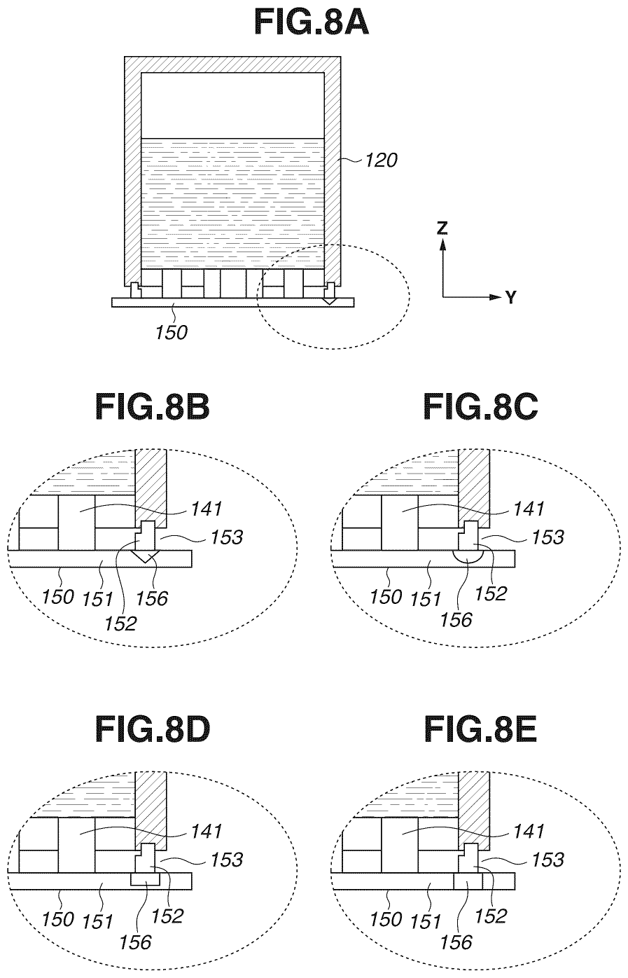

FIG. 8A is an outline diagram of the cartridge 100 according to the second exemplary embodiment as viewed from the X direction. The cartridge 100 according to the second exemplary embodiment is different from the cartridge 100 according to the first exemplary embodiment in that a concave portion 156 for guiding the separation pin (member) 4 from the gap 153 to the joining portion is provided. Even in a case where positional deviation occurs when the separation pin 4 is inserted into the gap 153 and is caused to abut on the joining portion, the separation pin 4 can be guided from the concave portion 156 to the gap 153 and to the joining portion by being pushed while abutting on the concave portion 156. FIGS. 8B to 8E are enlarged views of the joining portion between the liquid storage member 120 and the lid member 150. The concave portion 156 may have, for example, an opening with an opening width (in Y direction) of 1 mm or more, and a depth (in X direction) of 0.5 mm or more.

FIG. 8B illustrates the concave portion 156 having a triangular opening. When the opening of the concave portion 156 has such a shape, it is possible to accurately guide the separation pin 4 to the gap 153. As illustrated in FIG. 8C, the opening shape of the concave portion 156 may be a semicircular shape. When the opening of the concave portion 156 has such a shape, it is possible to increase a range where the separation pin 4 can be guided to the gap 153. As illustrated in FIG. 8D, the opening shape of the concave portion 156 may be a quadrangular shape. When the opening of the concave portion 156 has such a shape, it is possible to easily perform processing because of a simple shape. Further, as illustrated in FIG. 8E, the opening shape of the concave portion 156 may have a size equal to a thickness of the lid member 150. In this case, the processing is more easily performable as compared with the shape illustrated in FIG. 8D. Note that the opening shape of the concave portion 156 is not limited thereto, and may be a trapezoidal shape or other shapes.

Since the concave portion 156 guides the separation pin 4 from the gap 153 to the joining portion, at least a part of the opening of the concave portion 156 may be provided on the outside of the joining portion. The opening of the concave portion 156 may entirely be provided on the outside of the joining portion. As described above, since the separation pin 4 is preferably caused to abut on the joining portion from the side surface of the lid member 150 in the longitudinal direction, the concave portion 156 is preferably provided on the side surface of the lid member 150 in the longitudinal direction.

Further, the concave portion 156 preferably includes an inclined surface inclined toward the gap 153. This makes it possible to more easily guide the separation pin 4 from the gap 153 to the joining portion.

As described above, when the lid member includes the concave portion, the separation pin (member) can be easily guided to the gap. This makes it possible to further suppress the possibility that the liquid storage member is damaged.

### Method of Remanufacturing Cartridge

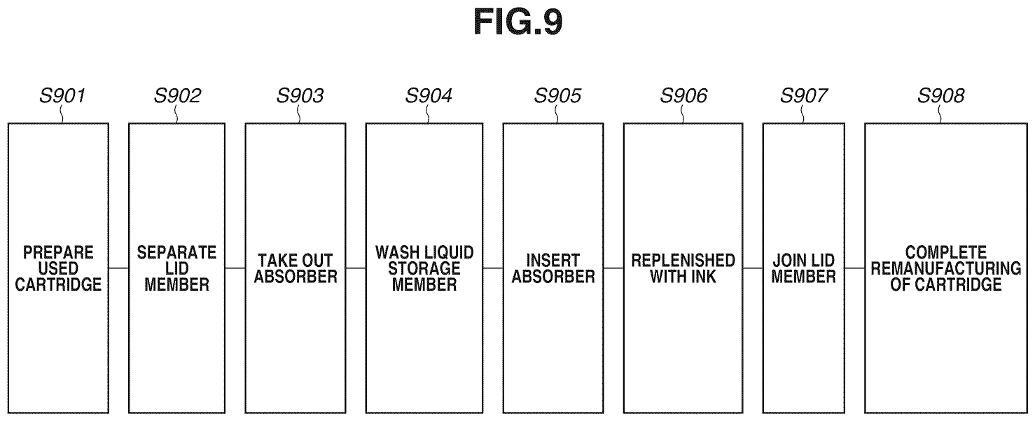

The method of remanufacturing the cartridge 100 is described. FIG. 9 illustrates a flow of the method of remanufacturing the cartridge 100. In step S901 illustrated in FIG. 9, the used cartridge 100 is prepared. For example, after the cartridge is distributed in market, the used cartridge is collected and prepared. At this time, a defective item that is not available for a reused item is preferably sorted out from collected items. In a first collected-item sorting step, sortation is performed based on models of the collected items. Generally, the shape of the liquid storage member 120 and types of used ink are different depending on the models of the cartridge 100. Thus, it may be useful to sort the cartridge 100 before the cartridge 100 is input to a production step. Further, it may be useful to consider a possibility that the ink cartridge not to be reused is mixed because of collected items.

In step S902, the lid member 150 is separated from the liquid storage member 120. The processing is a feature of the present exemplary embodiment. The method of separating the lid member 150 from the liquid storage member 120 is as described above.

In step S903, the absorber 130 is taken out from the liquid storage member 120.

In a case of the cartridge 100 not housing the absorber 130, the processing in step S903 can be omitted.

In step S904, the liquid storage member 120 is washed. In the washing step, an inside and an entire surface of the liquid storage member 120 of the cartridge 100 are washed with water and the like to remove dusts, ink stain, and the like, and the liquid storage member 120 is then dried.

In step S905, a new absorber (also referred to as second absorber) is inserted into the liquid storage member 120. The absorber 130 separated in step S903 may be washed and housed in the liquid storage member 120 again. In this case, washing of the absorber 130 is performed not only by impregnating the absorber 130 with washing liquid in one direction and then sucking and discharging the washing liquid, but also by impregnating the entire absorber 130 with the washing liquid and causing the washing liquid to permeate every corner of the absorber 130.

The absorber 130 is preferably washed while being pressed and deformed in the washing liquid because remaining ink can be eliminated.

In step S906, the liquid storage member 120 is replenished with new ink, and the second absorber is caused to hold the ink.

In step S907, a new lid member (second lid member) is joined to the liquid storage member 120. This can be performed by a method similar to the method of joining the lid member 150 to the liquid storage member 120, for example, thermal welding. When the lid member 150 is joined to the liquid storage member 120 once, the welding rib (convex portion) is reduced after the lid member 150 is separated from the liquid storage member 120. Therefore, in remanufacture of the cartridge 100, the new lid member (second lid member) is preferably used.

Note that, before the processing in step S907, the second lid member and the partition member 140 are preferably fixed by thermal swaging. This makes it possible to improve handling property in a subsequent step. Further, since the partition member 140 is not joined to the liquid storage member 120, the partition member 140 is preferably reused. By reusing the partition member 140, a weight recycling rate of the cartridge 100 can be improved, and the cartridge 100 more friendly to environment can be realized.

After the above-described steps, in step S908, remanufacture of the cartridge 100 is completed. The steps of remanufacturing the cartridge 100 are not limited to the above-described steps, and a step may be appropriately omitted or added depending on a situation.

As described above, according to the present disclosure, it is possible to provide the cartridge, the method of disassembling the cartridge that suppresses the possibility of occurrence of chips when the liquid storage member and the lid member are separated from each other, and the method of remanufacturing the cartridge. By reusing the liquid storage member 120, the cartridge 100 friendly to environment can be realized.

The technologies described in this specification have the potential to contribute to the achievement of a sustainable society, such as a decarbonized society/circular society.

Further, a form in which the configurations according to the above-escribed exemplary embodiments are appropriately combined can be adopted.

According to the exemplary embodiments, it is possible to provide the cartridge, the method of disassembling the cartridge that suppresses the possibility of occurrence of chips when the liquid storage member and the lid member are separated from each other, and the method of remanufacturing the cartridge.

While the present disclosure has been described with reference to exemplary embodiments, it is to be understood that the invention disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-043876, filed Mar. 19, 2024, which is hereby incorporated by reference herein in its entirety.

What is claimed is:

1. A method of disassembling a cartridge, the cartridge including a liquid storage member including an opening and configured to store liquid, and a lid member configured to cover the opening, the liquid storage member and the lid member being joined at a joining portion, a gap being provided between a rear surface of the lid member and the liquid storage member, the method comprising:
separating the liquid storage member and the lid member by inserting a member from the gap; and
causing the member to abut on the joining portion.

2. The method of disassembling the cartridge according to claim 1,
wherein the lid member includes an inclined surface connected to the gap and inclined toward the gap, and
wherein the method further comprises guiding the member to the gap by pushing the member while the member abuts on the inclined surface.

3. The method of disassembling the cartridge according to claim 1,
wherein the gap is provided on a side surface of the lid member in a longitudinal direction, and
wherein, in the separating, the member is inserted into the gap in the longitudinal direction.

4. The method of disassembling the cartridge according to claim 1,
wherein the joining portion is provided over a circumferential direction of the opening, and
wherein the gap is provided on an outside of the joining portion.

5. The method of disassembling the cartridge according to claim 4,
wherein the lid member includes a flat plate portion and a convex portion protruding from the flat plate portion in a thickness direction of the flat plate portion,
wherein the joining portion is formed by joining the convex portion to the liquid storage member, and
wherein the gap is provided between the liquid storage member and the flat plate portion.

6. The method of disassembling the cartridge according to claim 4,
wherein the lid member includes a concave portion connected to the gap, on a side surface of the lid member,
wherein at least a part of an opening of the concave portion is provided on an outside of the joining portion, and
wherein the method further comprises guiding the member to the gap by inserting the member into the concave portion.

7. A method of remanufacturing a cartridge, the cartridge including a liquid storage member including an opening and configured to store liquid, and a first lid member configured to cover the opening, the liquid storage member and the first lid member being joined at a joining portion, a gap being provided between a rear surface of the first lid member and the liquid storage member, the method comprising:
separating the liquid storage member and the first lid member by inserting a member from the gap and causing the member to abut on the joining portion;
replenishing the liquid storage member with liquid; and
joining the first lid member or a second lid member different from the first lid member to the liquid storage member to cover the opening.

8. The method of remanufacturing the cartridge according to claim 7,
wherein the first lid member includes an inclined surface connected to the gap and inclined toward the gap, and
wherein the method further comprises guiding the member to the gap by pushing the member while the member abuts on the inclined surface.

9. The method of remanufacturing the cartridge according to claim 7,
wherein the gap is provided on a side surface of the first lid member in a longitudinal direction, and
wherein, in the separating, the member is inserted into the gap in the longitudinal direction.

10. The method of remanufacturing the cartridge according to claim 7,
wherein the joining portion is provided over a circumferential direction of the opening, and
wherein the gap is provided on an outside of the joining portion.

11. The method of remanufacturing the cartridge according to claim 10,
wherein the first lid member includes a flat plate portion and a convex portion protruding from the flat plate portion in a thickness direction of the flat plate portion,
wherein the joining portion is formed by joining the convex portion to the liquid storage member, and
wherein the gap is provided between the liquid storage member and the flat plate portion.

12. The method of remanufacturing the cartridge according to claim 10,
wherein the first lid member includes a concave portion connected to the gap, on a side surface of the first lid member,
wherein at least a part of an opening of the concave portion is provided on an outside of the joining portion, and
wherein the method further comprises guiding the member to the gap by inserting the member into the concave portion.

13. A cartridge comprising:
a liquid storage member including an opening and configured to store liquid; and
a lid member configured to cover the opening,
wherein the liquid storage member and the lid member are joined at a joining portion,
wherein a gap is provided between a rear surface of the lid member and the liquid storage member,
wherein the joining portion is provided over a circumferential direction of the opening,
wherein the lid member includes a concave portion or an inclined surface connected to the gap, on a side surface of the lid member, the concave portion having an opening, and
wherein the gap, and at least a part of the opening of the concave portion or at least a part of the inclined surface are provided on an outside of the joining portion.

14. The cartridge according to claim 13, wherein the gap is provided on a side surface of the lid member in a longitudinal direction.

15. The cartridge according to claim 13,
wherein the lid member includes a flat plate portion and a convex portion protruding from the flat plate portion in a thickness direction of the flat plate portion,
wherein the joining portion is formed by joining the convex portion to the liquid storage member, and
wherein the gap is provided between the liquid storage member and the flat plate portion.

16. The cartridge according to claim 13,
wherein the liquid storage member internally includes an absorber configured to hold the liquid, and
wherein the lid member includes a protrusion configured to abut on the absorber.

17. The cartridge according to claim 13,
wherein the liquid storage member internally includes an absorber configured to hold the liquid, and
wherein the cartridge further comprises a partition member disposed between the absorber and the lid member and including a protrusion configured to abut on the absorber.

18. The cartridge according to claim 17,
wherein the lid member includes a support portion, and
wherein the partition member includes a fitting portion to which the support portion is fitted.

19. The cartridge according to claim 13, wherein the opening of the concave portion is entirely provided on the outside of the joining portion.
